(19) United States
(12) Patent Application Publication
(10) Pub. No.: US 2026/0225138 A1
(43) Pub. Date: Aug. 6, 2026

(54) BLOWER SYSTEM AND METHOD FOR OPERATING A CLEANING VEHICLE HAVING A BLOWER SYSTEM

(71) Applicant: OMEGA LIQUID WASTE SOLUTIONS INC., Lévis (CA)

(72) Inventors: Tony VACHON, St-Joseph-de-Beauce (CA); Steeve SHEEHY, Lévis (CA); Etienne JOUBERT, Candiac (CA)

(21) Appl. No.: 19/148,110

(22) PCT Filed: Feb. 20, 2024
(86) PCT No.: PCT/CA2024/050204

§ 371 Date: Jul. 15, 2025

Related U.S. Application Data
(60) Provisional application No. 63/485,966, filed on Feb. 20, 2023.

(51) Int. Cl. B08B 9/08; F15B 15/18

(52) U.S. Cl. CPC B08B 9/08; F15B 15/18; B08B 2209/08

(57) ABSTRACT

A blower system mountable to a cleaning vehicle includes a hydraulic pump, a hydraulic motor hydraulically connected to the hydraulic pump, a direction valve hydraulically connected between the hydraulic pump and the hydraulic motor, the direction valve movable between a first position such that hydraulic fluid flows in the hydraulic motor in a first direction, and a second position such that hydraulic fluid flows in the hydraulic motor in a second direction opposite the first direction, and a blower operatively connected to the hydraulic motor. The blower is operable in a first direction causing operation of the blower in a vacuum operating mode, and in a second direction causing operation of the blower in a pressurizing mode. A method for operating a cleaning system having a blower system is also disclosed.

### FIELD

The improvements generally relate to blower systems for cleaning vehicle applications, and to methods for operating a cleaning vehicle having such blower systems.

### BACKGROUND

Blower systems are used in applications where liquids are pumped into and out of a reservoir. Among various applications, cleaning vehicles use blower systems for pumping liquid from a liquid source, such as a sewer, into a reservoir mounted to the cleaning vehicle, and for pumping the liquid out of the reservoir. Some cleaning vehicles use blower systems without air injection for low vacuum use (i.e. where a gauge pressure in the reservoir is up to 15 inHg). Different blower systems with air injection are used in high vacuum applications (i.e. where a gauge pressure in the reservoir is above 15 inHg). On such blower systems, a blower of the blower system in configured to operate in a unidirectional fashion (i.e. rotors of the blower are operable in one direction) generally indicated by an arrow marked on the housing of the blower. The unidirectional operation of the blower is selected for one of vacuuming or pressurizing the reservoir, and a four-way valve is used to allow the same blower to be used for another one of vacuuming or pressurizing the reservoir.

Various configurations of blower systems exist, and most forms are adapted to specific applications, such as cleaning vehicles.

For instance, one example of a conventional blower system 10 configuration for a high vacuum application in a cleaning vehicle 12 is illustrated in FIGS. 1A and 1B. In this example, the blower system 10 has a reservoir 14, a primary shutoff valve 16, a secondary shutoff valve 18, a filter 20, a four-way valve 22 fluidly connected between the filter 20 and a blower 24, and an exhaust 26 fluidly connected to the blower 24.

When operating in a vacuum mode (FIG. 1A), the blower 24 is operated in the direction indicated by arrow 28 provided on the blower 24, and the four-way valve 22 is configured for (i) allowing passage of air from the filter 20 and to an inlet 24a of the blower 24, and (ii) allowing passage of air from an outlet 24b of the blower 24 through the four-way valve 22 and on to the exhaust 26.

When operating in a pressurizing mode (FIG. 1B), the blower 24 is still operated in the direction indicated by arrow 28 provided on the blower 24, and the four-way valve 22 is configured for (i) allowing passage of air from the exhaust 26 and to the inlet 24a of the blower 24, and (ii) allowing passage of air from the outlet 24b of the blower 24 through the four-way valve 22 and on to the filter 20 and ultimately to the reservoir 14.

Under certain conditions, during operation of the blower system 10, the four-way valve 22 obstructs passage of air, induces turbulent air flow in the blower system 10, and produces undesirable noise emissions. The four-way valve 22 is also bulky and challenging to package in the blower system 10.

Referring to FIG. 2, an illustrative embodiment of such a blower system 10 is presented. While the blower 24 is concealed within an enclosure 32, the four-way valve 22 and the filter 20 are disposed externally of the enclosure 32. For example, the four-way valve 22 needs to be easily accessed, so it is not convenient to dispose it inside the enclosure 32. In some operating conditions, the flow of air through the four-way valve 22 and the filter 20 can cause noises emissions greater than 100 dBa, and typically around 102 to 104 dBa.

Although such blower systems are satisfactory to a certain extent, there remains room for improvement, especially in providing improved or alternate blower system configurations adapted to cleaning applications with features such as reduced noise, comparable or improved efficiency, and smaller packaging.

### SUMMARY

In accordance with one aspect, there is provided a method for operating a cleaning vehicle having a chassis, a reservoir mounted to the chassis, a conduit fluidly connecting a fluid source to the reservoir, and a blower system mounted to the chassis and adapted to entrain a flow of fluid along the conduit, the method including, with the cleaning vehicle at a first location, operating the blower system in a vacuum mode for pumping fluid from the fluid source to the reservoir, the blower system operating in a first speed regime and in a first direction and causing a gauge pressure in the reservoir to be greater than 16 inHg, a vacuum provided by the blower system drawing fluid from the fluid source into the reservoir through the conduit, moving the cleaning vehicle from the first location to a second location different from the first location, and with the cleaning vehicle at the second location, operating the blower system in a pressurizing mode for pumping the fluid out of the reservoir, the blower system operating in a second speed regime different from the first speed regime and in a second direction opposite the first direction and causing a gauge pressure in the reservoir to be greater than 2 PSI, a pressure provided by the blower system in the reservoir drawing fluid out of the reservoir.

In some embodiments, the blower system includes a hydraulic pump operatively connected to a drivetrain component of the cleaning vehicle, a hydraulic motor hydraulically connected to the hydraulic pump, a direction valve hydraulically connected between the hydraulic pump and the hydraulic motor, the direction valve movable between a first position such that hydraulic fluid flows in the hydraulic motor in the first direction, and a second position such that hydraulic fluid flows in the hydraulic motor in the second direction, and a blower operatively connected to the hydraulic motor. When the direction valve is in the first position, hydraulic fluid flows in the hydraulic motor in the first direction and causes operation of the blower in the first direction. When the direction valve is in the second position, hydraulic fluid flows in the hydraulic motor in the second direction and causes operation of the blower in the second direction.

In some embodiments, the cleaning vehicle further includes at least one of a conduit reel and a rotating filter operatively connected to the hydraulic motor. When the direction valve is in the first position, flowing hydraulic fluid in the hydraulic motor in the first direction and causing operation of the at least one of the conduit reel and the rotating filter in the first direction. When the direction valve is in the second position, flowing hydraulic fluid in the hydraulic motor in the second direction and causing operation of the at least one of the conduit reel and the rotating filter in the second direction.

In some embodiments, when in the vacuum mode, the gauge pressure in the reservoir is greater than 20 inHg.

In some embodiments, when in the vacuum mode, the gauge pressure in the reservoir is greater than 25 inHg.

In some embodiments, when in the vacuum mode, the gauge pressure in the reservoir is greater than 27 inHg.

In some embodiments, when in the pressurizing mode, the gauge pressure in the reservoir is comprised between 5 and 10 PSI.

In some embodiments, a magnitude of the first speed regime is greater than a magnitude of the second speed regime.

In some embodiments, the second speed regime is between 40% and 60% slower than the first speed regime.

In accordance with another aspect, there is provided a blower system mountable to a cleaning vehicle having chassis, a reservoir mounted to the chassis, and a conduit fluidly connecting a fluid source to the reservoir, the blower system including a hydraulic pump operatively connected to a drivetrain component of the cleaning vehicle, a hydraulic motor hydraulically connected to the hydraulic pump, a direction valve hydraulically connected between the hydraulic pump and the hydraulic motor, the direction valve movable between a first position such that hydraulic fluid flows in the hydraulic motor in a first direction, and a second position such that hydraulic fluid flows in the hydraulic motor in a second direction opposite the first direction, and a blower operatively connected to the hydraulic motor. When the direction valve is in the first position, hydraulic fluid flows in the hydraulic motor in the first direction and causes operation of the blower in a vacuum operating mode and causing a gauge pressure in the reservoir to be greater than 16 inHg, the vacuum provided by the blower system drawing fluid from the fluid source into the reservoir through the conduit. When the direction valve is in the second position, hydraulic fluid flows in the hydraulic motor in the second direction and causes operation of the blower in a pressurizing mode and causing a gauge pressure in the reservoir to be greater than 2 PSI, the pressure provided by the blower system in the reservoir drawing fluid out of the reservoir through the conduit.

In some embodiments, when in the vacuum operating mode, the blower operating at a first speed regime, and when in the pressurizing mode, the blower operating at a second speed regime different from the first speed regime.

In some embodiments, a magnitude of the first speed regime is greater than a magnitude of the second speed regime.

In some embodiments, the second speed regime is between 40% and 60% slower than the first speed regime.

In some embodiments, the blower system further includes a filter fluidly connected between the blower and the reservoir, and an acoustically insulated casing at least partially enclosing the blower and the filter.

In some embodiments, the blower includes a housing defining an intake and an exhaust, first and second rotors each having a tri-lobe configuration, the first and second rotors shaped and configured for rotating in opposite directions within the housing and drawing fluid between the intake and the exhaust, when the blower operates in the pressurizing mode, fluid drawn from the intake cools down the first and second rotors, and when the blower operates in the vacuum mode, fluid drawn from the reservoir cools down the first and second rotors.

In accordance with yet another aspect, there is provided a blower system mountable to a chassis of a cleaning vehicle, including a blower, a filter fluidly connected directly to the blower, and an acoustically insulated casing at least partially enclosing the blower and the filter.

In some embodiments, the blower system further includes a hydraulic pump operatively connectable to a power source, a hydraulic motor hydraulically connected to the hydraulic pump, the hydraulic motor operatively connected to the blower, a direction valve hydraulically connected between the hydraulic pump and the hydraulic motor, the direction valve movable between a first position such that hydraulic fluid flows in the hydraulic motor in a first direction, and a second position such that hydraulic fluid flows in the hydraulic motor in a second direction opposite the first direction, when the hydraulic pump is connected to the power source and when the direction valve is in the first position, hydraulic fluid flows in the hydraulic motor in the first direction and causes operation of the blower in a vacuum mode; and when the hydraulic pump is connected to the power source and when the direction valve is in the second position, hydraulic fluid flows in the hydraulic motor in the second direction and causes operation of the blower in a pressurizing mode.

In some embodiments, when in the vacuum mode, the blower is operable at a first speed regime, and when in the pressurizing mode, the blower is operable at a second speed regime different from the first speed regime.

In some embodiments, a magnitude of the first speed regime is greater than a magnitude of the second speed regime.

In some embodiments, the second speed regime is between 40% and 60% slower than the first speed regime.

In some embodiments, the blower includes a housing defining an intake and an exhaust, first and second rotors each having a tri-lobe configuration, the first and second rotors rotating in opposite directions within the housing and drawing fluid between the intake and the exhaust, when the blower operates in the pressurizing mode, fluid drawn from the intake cools down the first and second rotors, and when the blower operates in the vacuum mode, fluid drawn by the blower cools down the first and second rotors.

Many further features and combinations thereof concerning the present improvements will appear to those skilled in the art following a reading of the instant disclosure.

### BRIEF DESCRIPTION OF THE FIGURES

In the figures,

FIG. 1A is a schematic view of an example of a blower system, in accordance with the prior art, with the blower system operating in a vacuum mode;

FIG. 1B is a schematic view of the blower system of FIG. 1A, with the blower system operating in a pressurizing mode;

FIG. 2 is a photograph of the blower system of FIG. 1A;

FIG. 3 is a schematic view of an example of a cleaning vehicle having a blower system, in accordance with one embodiment;

FIG. 4A is a perspective view of a blower of the blower system of FIG. 3;

FIG. 4B is a schematic view of the rotors and housing of the blower of FIG. 4A;

FIGS. 5A to 5F are different plan views of components of the blower system of FIG. 3, with walls of a casing shown in transparency;

FIG. 6 is a schematic view of the blower system of FIG. 3, with the blower system operating in a vacuum mode;

FIG. 7 is a schematic view of the blower system of FIG. 3, with the blower system operating in a pressurizing mode; and

FIG. 8 is a flowchart of a method for operating a cleaning vehicle having a blower system, in accordance with one embodiment.

### DETAILED DESCRIPTION

In the following description, the term “fluid” is understood to include a gas, such as air, a liquid, such as water, or a mixture of a gas and a liquid. The term “hydraulic fluid” is understood to include hydraulic oil and/or other liquids suitable for use in a hydraulic system. “Gauge pressure” is used as a method of indicating a vacuum level or a pressure level. As used herein, “vacuuming” or “vacuum” is a condition of sub-normal atmospheric pressure. “Pressurizing” or “pressurization” is a condition of above-normal atmospheric pressure. In the present description, the units of vacuum pressure are inches of mercury (inHg), and the units of pressurizing (or pressurization) are pounds per square inch (PSI). “Zero inches of mercury” and “zero PSI” means atmospheric pressure, with no vacuum or pressurization at all. High numbers (e.g., 25 inHg) mean high vacuum suction levels (the highest possible vacuum level measured in this way would be 29.92 inHg). Depending on the context in which the word vacuum is used, a “high” vacuum is referred to herein as a pressure below atmospheric pressure.

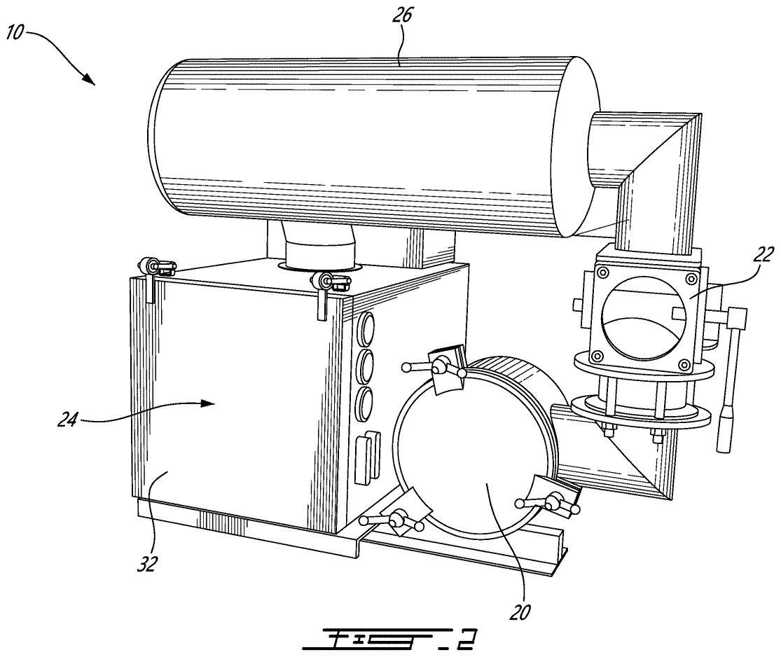

FIG. 3 shows an example of a cleaning vehicle 112, in accordance with an embodiment. As depicted, the cleaning vehicle 112 has a chassis 114 to which are mounted a reservoir 116, and a high pressure (or high vacuum) cleaning system 118 including a blower system 120. An aspiration conduit 130 is fluidly connected to the blower system 120, and the blower system 120 is adapted to entrain a flow of fluid along the conduit 130. The blower system 120 and the aspiration conduit 130 are used to fill the reservoir 116 with fluid 124 from a fluid source 126. More specifically, the conduit 130 has a first end 130a extending into the fluid source 126 and a second end 130b leading into the reservoir 116. The blower system 120 is used to create a vacuum inside the reservoir 116 which can cause aspiration of fluid 124 from the fluid source 126 to the reservoir 116 through the conduit 130. The blower system 120 is also used to pressurize the reservoir 116 to draw the fluid 124 out of the reservoir 116 through a discharge outlet.

Other components can be mounted either directly or indirectly to the chassis 114, as will become apparent for the skilled reader. To name one possible example amongst a wide range of possible applications, for instance, the cleaning vehicle 112 includes a filtration subsystem 122 including a rotating filter 125 which can be similar to embodiments described in patent application PCT/CA2017/051309 filed on Nov. 3, 2017 and titled “Cleaning vehicle and high pressure cleaning systems”, the entire contents of which is incorporated by reference herein. The cleaning vehicle 112 further has a motorized conduit reel 128 adapted for selectively winding or unwinding the conduit 130. Such latter features are entirely optional.

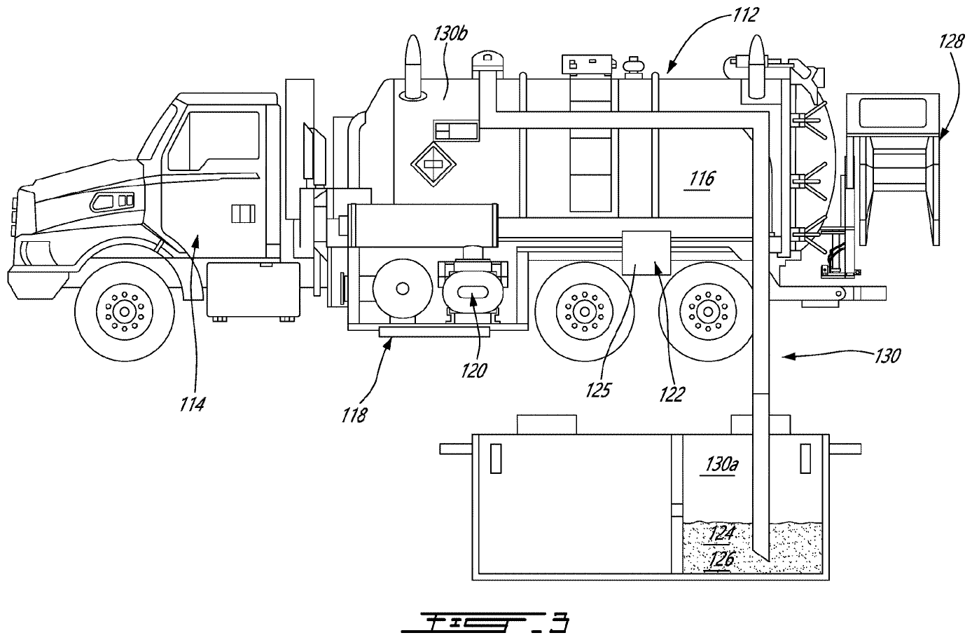

Before describing the operating modes of the blower system 120, different components of the blower system 120 will be described. Referring to FIGS. 4A and 4B, a blower 140 is shown. The blower 140 has a housing 142 defining an intake 144, an outlet 146 and two air injection ports 148. The blower 140 further has first and second rotors 150 each having a tri-lobe configuration. The blower 140 is a positive displacement fluid pump. The movement of the rotors 150 is synchronized by timing gears located on shafts of the blower 140. There is no friction between the rotors 150, and between the rotors 150 and the housing 142. It is contemplated that the rotors 150 could be made of a material different from the material forming the housing 142. For example, the housing 142 could be made of a metallic material and the rotors 150 or a portion thereof could be made of a composite-reinforced plastic material. A clearance 152 is defined between the rotors 150 and the housing 142. The clearance 152 is selected to allow the rotors 150 to rotate in the directions indicated by the arrows 150a, 150b, or in the directions indicated by the dashed arrows 150c, 150d (depending on the operating mode of the blower 140 as will become apparent from the description below) while limiting overheating of the rotors 150 and maintaining satisfactory performances of the blower 140 in view of the requirements of the cleaning vehicle 112. In some embodiments, the clearance 152 is selected to further take into account centripetal force and thermal expansion to which the rotors 150 are subjected during rotation thereof. To improve cooling of the rotors 150, channels 155 (schematically shown in FIG. 4B) are defined on the housing 142 near the outlet 146.

During the rotation of the rotors 150 in the directions 150a, 150b, the fluid is moved by the rotors 150 from the intake 144 and transferred to the outlet 146. The blower 140 can thus operate in a vacuum mode or in a pressurizing mode. The capacity (i.e. volume of fluid moved per minute) of the blower 140 depends on its operating speed (i.e. revolutions per minute (RPM) of the rotors 150), its dimensions and pressure conditions.

In some embodiments, when in the pressurizing mode, the blower 140 operates in a speed regime that is reduced compared to the speed regime typically used in the vacuum mode. In other words, a magnitude of the speed regime in the vacuum mode is greater than a magnitude of the speed regime in the pressurizing mode. In some embodiments, the speed regime in the pressurizing mode is between 40% and 60% slower than the speed regime of the vacuum mode. For example, when in the pressurizing mode, the speed regime ranges between 1120 and 1600 rpm. Using such a slower speed regime in the pressurizing mode may assist in reducing heat generated by the blower system 120 during operation thereof.

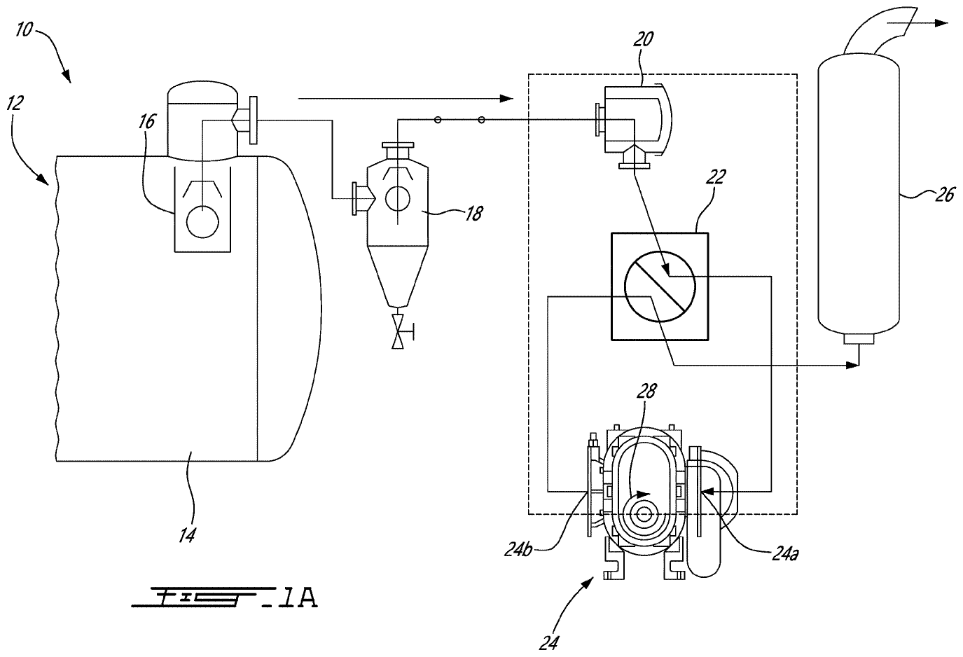

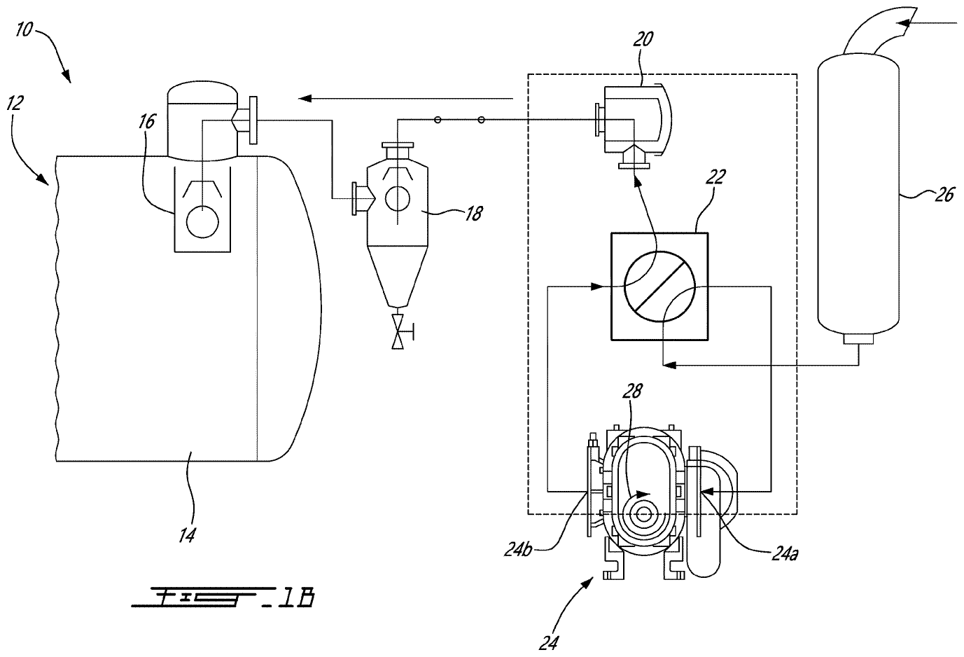

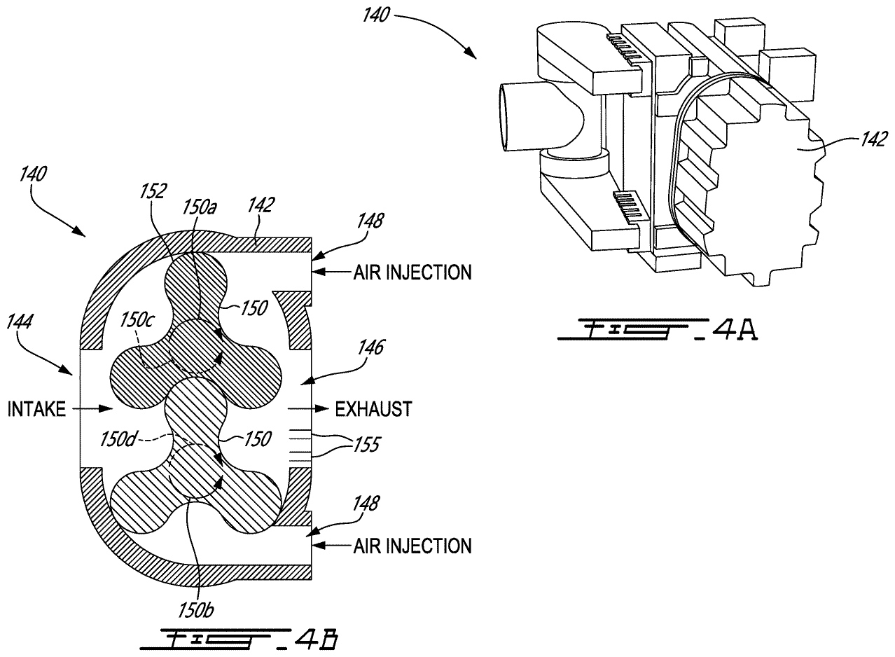

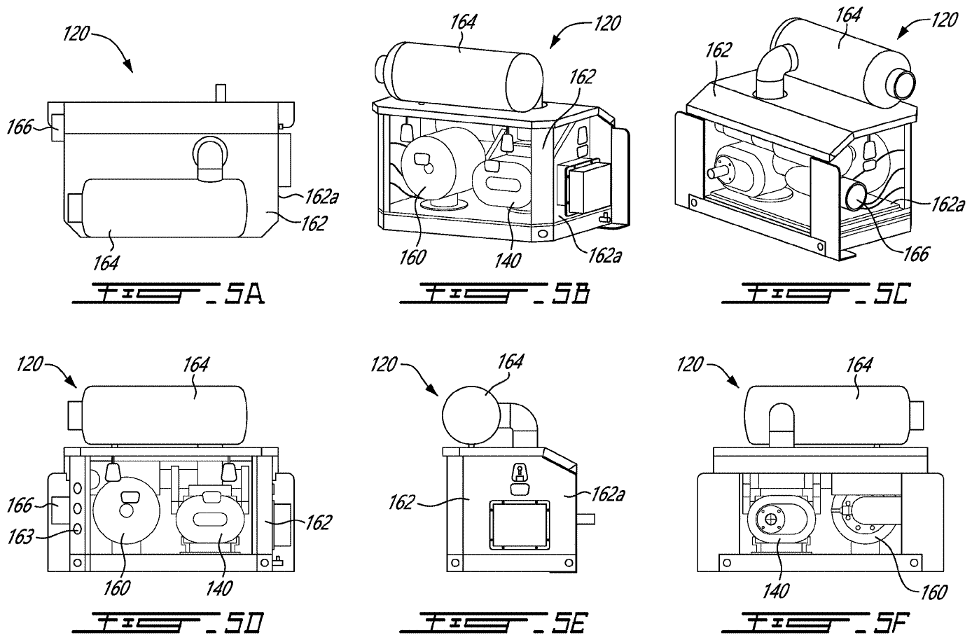

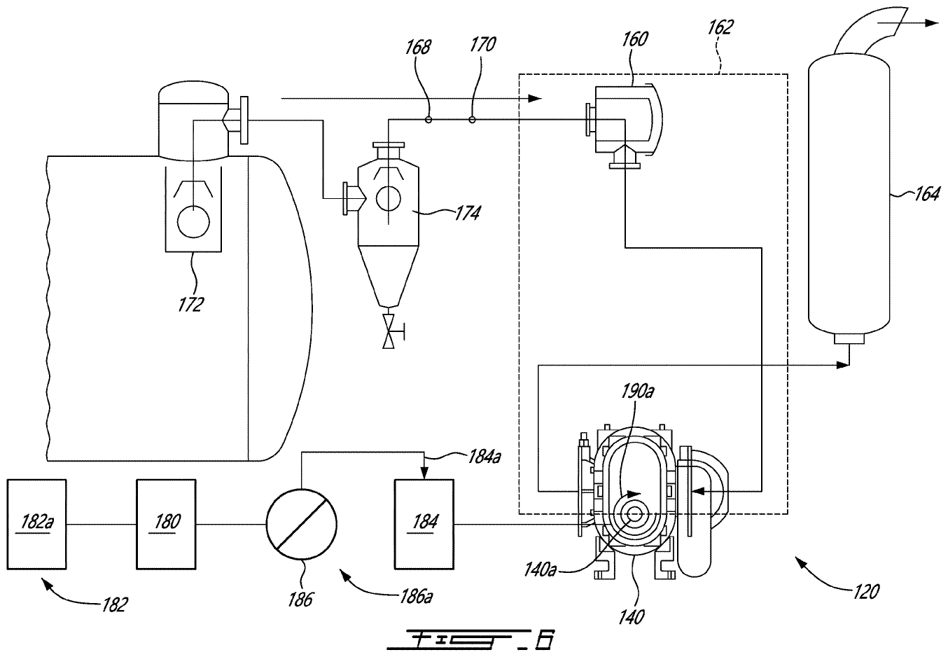

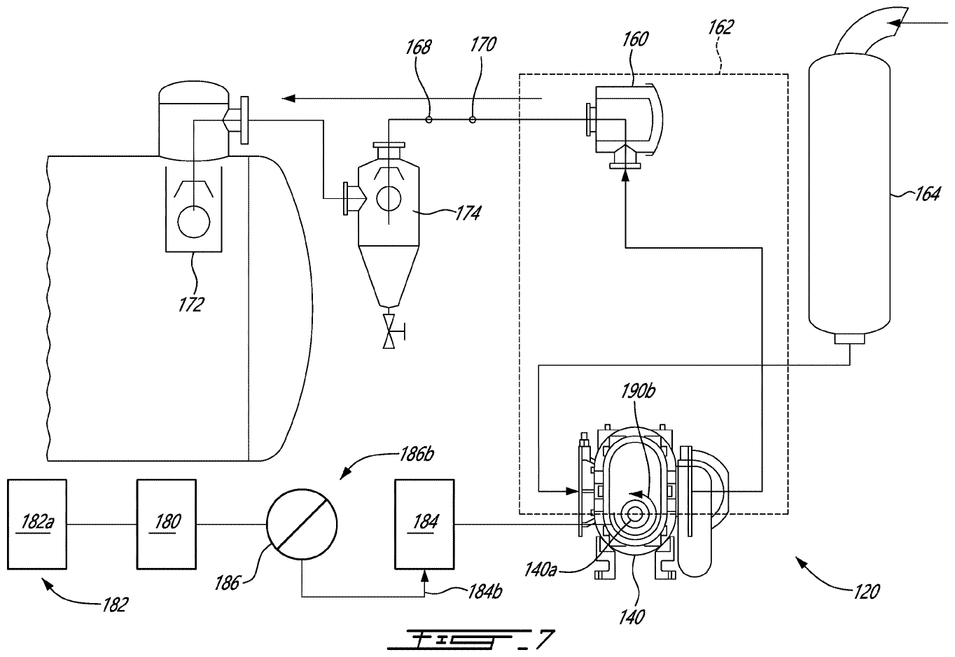

Referring to FIGS. 5A to 5F, the blower system 120 further includes a filter 160 fluidly connected to the blower 140. The filter 160 is fluidly connected directly to the blower 140. In other words, there is no fluid flow altering components disposed therebetween, such as a valve. In contrast with the blower system 10 presented in FIGS. 1A and 1B, there is no four-way valve fluidly connected between the blower 140 and the filter 160. In some embodiments, the filter 160 is a final filter of the blower system 120. The blower system 120 further includes an acoustically insulated casing 162 enclosing the blower 140 and the filter 160. Sidewall 162a of the casing are shown in transparency in FIGS. 5A to 5F. The casing 162 may contain additional components of the blower system 120, such as a cooling system and pressure gauges 163 (FIG. 5D). A muffler 164 is fluidly connected to the blower 140 and is disposed on top of the casing 162. An intake 166 is fluidly connected to the filter 160, and is fluidly connectable to the reservoir 116. The casing 162 may assist in reducing noise emissions from the blower 140 and filter 160 when the blower 140 is operating. For example, under certain conditions, noise emissions can be reduced from around 102 to 104 dBa to around 81 dBa.

As mentioned above, it is to be noted that the blower system 120 is free of a four-way valve used in conventional blower systems, such as the blower system 10 presented in FIGS. 1A and 1B. This lack of four-way valve permits to package at least some components of the blower system 120 into a smaller volume compared to a conventional blower system, and to dispose the blower 140 and the filter 160 inside the casing 162. It also permits the blower system 120 to be mounted on smaller cleaning vehicles 112 compared to the conventional cleaning vehicles.

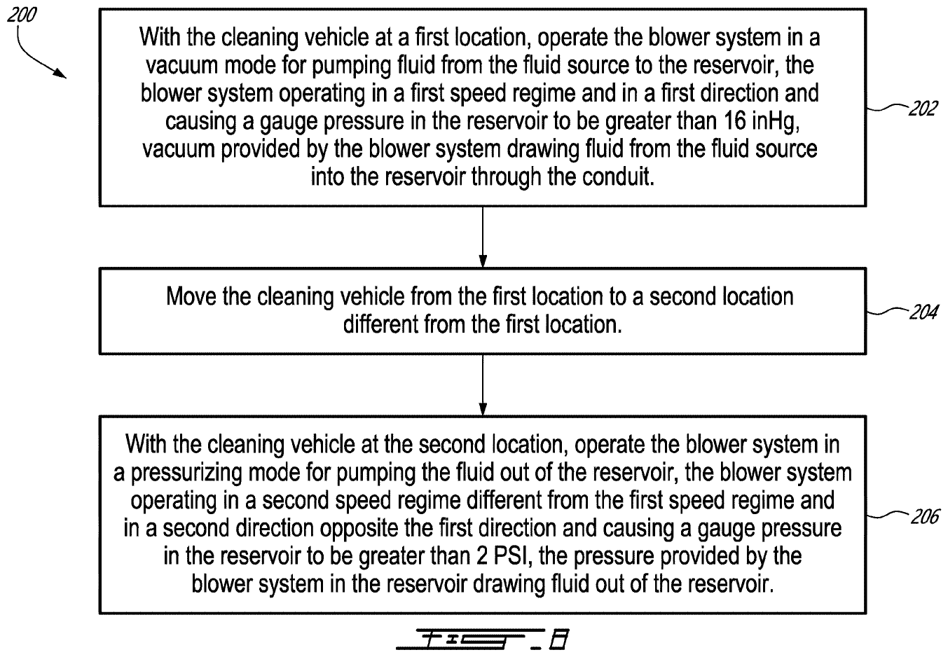

Referring to FIGS. 6 and 7, an overpressure valve 168 is provided between the filter 160 and the reservoir 116, and is configured to open when the pressure in the reservoir 116 and/or conduit 130 reaches 10 PSI. The overpressure valve 168 permits to operate the blower 140 continuously when in the pressurizing mode and allow for fresh air to be drawn by the blower 140 and cool down the rotors 150. This limits the heating of the rotors 150 and housing 142 when in the pressurizing mode. A vacuum relief valve 170 is also provided between the filter 160 and the reservoir 116. A primary shutoff valve 172 and a secondary shutoff valve 174 are also fluidly connected between the reservoir 116 and the filter 160.

Still referring to FIGS. 6 and 7, the blower system 120 further includes a hydraulic pump 180 operatively connected to a power source 182. The power source 182 in the present embodiment is a drivetrain component 182a of the cleaning vehicle 112a (such as a driveshaft of the cleaning vehicle 112a), but it is contemplated that other suitable power source 182 could be used. A hydraulic motor 184 is hydraulically connected to the hydraulic pump 180. The hydraulic motor 184 is operatively connected to the blower 140 and provides motive power to rotate the rotors 150. A direction valve 186 is hydraulically connected between the hydraulic pump 180 and the hydraulic motor 184. The direction valve 186 is movable between a position 186a (FIG. 6) such that hydraulic fluid flows in the hydraulic motor 184 in direction 184a, and a position 186b (FIG. 7) such that the hydraulic fluid flows in the hydraulic motor 184 in direction 184b being opposite direction 184a. In other words, the direction valve 186 is movable between positions 186a, 186b and causes the hydraulic motor 184 to be selectively operated in directions 184a, 184b respectively.

Referring to FIG. 6, when the hydraulic pump 180 is connected to the power source 182 and when the direction valve 186 is in position 186a, the hydraulic fluid flows in the hydraulic motor 184 in direction 184a and causes operation of the blower 140 in vacuum mode. When in the vacuum mode, an input shaft 140a of the blower 140 operatively connected to the hydraulic motor 184 rotates in direction 190a, which causes rotation of the rotors 150 in directions 150a, 150b (FIG. 4B). When in vacuum mode, the blower system 120 causes a gauge pressure in the reservoir 116 to be greater than 16 inHg. In some embodiments, the gauge pressure in the reservoir 116 is greater than 20 inHg. In some embodiments, the gauge pressure in the reservoir 116 is greater than 25 inHg. In some embodiments, the gauge pressure in the reservoir 116 is greater than 27 inHg. The vacuum relief valve 170 is adapted to open at a gauge pressure selected based on the target gauge pressure of the reservoir 116 in the vacuum mode. The blower system 120 is thus adapted for providing a high vacuum in the reservoir 116 and cause an aspiration force adapted to draw fluid 124 from the fluid source 126 to the reservoir 116.

Conversely and with reference to FIG. 7, when the hydraulic pump 180 is connected to the power source 182 and when the direction valve 186 is in position 186b, the hydraulic fluid flows in the hydraulic motor 184 in direction 184b and causes operation of the blower 140 in pressurizing mode. When in the pressurizing mode, the input shaft 140a rotates in direction 190b, which causes rotation of the rotors 150 in directions 150c, 150d (FIG. 4B). When in the pressurizing mode, the blower system 120 causes a gauge pressure in the reservoir 116 to be comprised between 5 and 10 PSI. The upper limit of this range may be selected based on the configuration of the overpressure valve 168.

It is to be noted that such a configuration of the blower system 120 differs from the one found in some conventional cleaning vehicles where the blower is operatively connected to the driveshaft of the cleaning vehicle, making it impractical to operate the blower in different directions. Advantageously, using the hydraulic pump 180, hydraulic motor 184 and direction valve 186 permits selective mode of operation of the blower 140 (i.e. in vacuum mode or pressurizing mode) and permits to power other components of the cleaning vehicle 112, such as, and not limited to, the conduit reel 128 and filtration subsystem 122 (schematically presented). The conduit reel 128 and the filtration subsystem 122 may also include dedicated direction valves adapted to operate each one of these components in a direction that is independent from the directions 184a, 184b of the hydraulic motor 184.

Referring to FIG. 8, a method 200 for operating the cleaning vehicle 112 is presented. At step 202, with the cleaning vehicle 112 being at a location such as a site where fluid 124 is to be vacuumed, the blower system 120 is operated in the vacuum mode for pumping fluid 124 from the fluid source 126 to the reservoir 116. The blower system 120, through the hydraulic motor 184 operating in direction 184a and causing the rotors 150 to rotate in directions 150a, 150b, is operated in a speed regime causing the gauge pressure in the reservoir 116 to be above 16 inHg. As mentioned above, the gauge pressure in the reservoir 116 is contemplated to be greater than 20 inHg, greater than 25 inHg, or greater than 27 inHg under certain conditions. The vacuum provided by the blower system 120 draws fluid 124 from the fluid source 126 into the reservoir 116 through the conduit 130.

At step 204, the cleaning vehicle 112 is moved from its location to another location, for example to a discharge site.

At step 206, with the cleaning vehicle 112 being at the other location, the blower system 120 is operated in the pressurizing mode for pumping the fluid 124 out of the reservoir 116. The blower system 120, through the hydraulic motor 184 operating in direction 184b and causing the rotors 150 to rotate in directions 150c, 150d, is operated in a different speed regime and causes the gauge pressure in the reservoir 116 to be greater than 2 PSI. As mentioned above, the gauge pressure in the reservoir 116 could be comprised between 5 and 10 PSI under certain conditions. The pressure provided by the blower system 120 in the reservoir 116 draws fluid 124 out of the reservoir 116 through the conduit 130 and/or the discharge outlet.

As can be understood, the examples described above and illustrated are intended to be exemplary only. For instance, the specific combination of elements is exemplary and can vary in alternate embodiments. Moreover, the high pressure cleaning system can be mounted to another form of frame than a chassis, and be used in other applications than the cleaning vehicle example described above. The scope is indicated by the appended claims.

1. A method for operating a cleaning vehicle having a chassis, a reservoir mounted to the chassis, a conduit fluidly connecting a fluid source to the reservoir, and a blower system mounted to the chassis and adapted to entrain a flow of fluid along the conduit, comprising:
with the cleaning vehicle at a first location, operating the blower system in a vacuum mode for pumping fluid from the fluid source to the reservoir, the blower system operating in a first speed regime and in a first direction and causing a gauge pressure in the reservoir to be greater than 16 inHg, a vacuum provided by the blower system drawing fluid from the fluid source into the reservoir through the conduit;
moving the cleaning vehicle from the first location to a second location different from the first location; and
with the cleaning vehicle at the second location, operating the blower system in a pressurizing mode for pumping the fluid out of the reservoir, the blower system operating in a second speed regime different from the first speed regime and in a second direction opposite the first direction and causing a gauge pressure in the reservoir to be greater than 2 PSI, a pressure provided by the blower system in the reservoir drawing fluid out of the reservoir.

2. The method of claim 1, wherein;
the blower system has
a hydraulic pump operatively connected to a drivetrain component of the cleaning vehicle,
a hydraulic motor hydraulically connected to the hydraulic pump,
a direction valve hydraulically connected between the hydraulic pump and the hydraulic motor, the direction valve movable between a first position such that hydraulic fluid flows in the hydraulic motor in the first direction, and a second position such that hydraulic fluid flows in the hydraulic motor in the second direction, and
a blower operatively connected to the hydraulic motor; and
wherein:
when the direction valve is in the first position, hydraulic fluid flows in the hydraulic motor in the first direction and causes operation of the blower in the first direction; and
when the direction valve is in the second position, hydraulic fluid flows in the hydraulic motor in the second direction and causes operation of the blower in the second direction.

3. The method of claim 2, wherein the cleaning vehicle further comprises at least one of a conduit reel and a rotating filter operatively connected to the hydraulic motor; and wherein:
when the direction valve is in the first position, flowing hydraulic fluid in the hydraulic motor in the first direction and causing operation of the at least one of the conduit reel and the rotating filter in the first direction; and
when the direction valve is in the second position, flowing hydraulic fluid in the hydraulic motor in the second direction and causing operation of the at least one of the conduit reel and the rotating filter in the second direction.

4. The method of claim 1, wherein, when in the vacuum mode, the gauge pressure in the reservoir is greater than 20 inHg.

5. The method of claim 4, wherein, when in the vacuum mode, the gauge pressure in the reservoir is greater than 25 inHg.

6. The method of claim 4, wherein, when in the vacuum mode, the gauge pressure in the reservoir is greater than 27 inHg.

7. The method of claim 1, wherein, when in the pressurizing mode, the gauge pressure in the reservoir is comprised between 5 and 10 PSI.

8. The method of claim 1, wherein a magnitude of the first speed regime is greater than a magnitude of the second speed regime.

9. The method of claim 8, wherein the second speed regime is between 40% and 60% slower than the first speed regime.

10. A blower system mountable to a cleaning vehicle having chassis, a reservoir mounted to the chassis, and a conduit fluidly connecting a fluid source to the reservoir, the blower system comprising:
a hydraulic pump operatively connected to a drivetrain component of the cleaning vehicle,
a hydraulic motor hydraulically connected to the hydraulic pump,
a direction valve hydraulically connected between the hydraulic pump and the hydraulic motor, the direction valve movable between a first position such that hydraulic fluid flows in the hydraulic motor in a first direction, and a second position such that hydraulic fluid flows in the hydraulic motor in a second direction opposite the first direction, and
a blower operatively connected to the hydraulic motor;
wherein:
when the direction valve is in the first position, hydraulic fluid flows in the hydraulic motor in the first direction and causes operation of the blower in a vacuum operating mode and causing a gauge pressure in the reservoir to be greater than 16 inHg, the vacuum provided by the blower system drawing fluid from the fluid source into the reservoir through the conduit; and
when the direction valve is in the second position, hydraulic fluid flows in the hydraulic motor in the second direction and causes operation of the blower in a pressurizing mode and causing a gauge pressure in the reservoir to be greater than 2 PSI, the pressure provided by the blower system in the reservoir drawing fluid out of the reservoir through the conduit.

11. The blower system of claim 10, wherein,
when in the vacuum operating mode, the blower operating at a first speed regime, and
when in the pressurizing mode, the blower operating at a second speed regime different from the first speed regime.

12. The blower system of claim 11, wherein a magnitude of the first speed regime is greater than a magnitude of the second speed regime.

13. The blower system of claim 12, wherein the second speed regime is between 40% and 60% slower than the first speed regime.

14. The blower system of claim 10, further comprising:
a filter fluidly connected between the blower and the reservoir; and
an acoustically insulated casing at least partially enclosing the blower and the filter.

15. The blower system of claim 10, wherein the blower comprises:
a housing defining an intake and an exhaust,
first and second rotors each having a tri-lobe configuration, the first and second rotors shaped and configured for rotating in opposite directions within the housing and drawing fluid between the intake and the exhaust,
wherein:
when the blower operates in the pressurizing mode, fluid drawn from the intake cools down the first and second rotors, and
when the blower operates in the vacuum mode, fluid drawn from the reservoir cools down the first and second rotors.

16. to 21. (canceled)
